(19) United States
(12) Patent Application Publication
(10) Pub. No.: US 2008/0009188 A1
(43) Pub. Date: Jan. 10, 2008

(54) Electrical connector assembly with reinforcing frame

(75) Inventor: Hao-Yun Ma, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/825,226

(22) Filed: Jul. 5, 2007

(30) Foreign Application Priority Data
Jul. 4, 2006 (CN) 200620074742.X

(51) Int. Cl. H01R 13/58

(52) U.S. Cl. 439/606

(57) ABSTRACT

An electrical connector assembly includes an insulative housing (1), and a reinforcing frame (4) removably disposed on the insulative housing. The insulative housing includes a base (10) having a top side, and side walls (11) upwardly extending from the top side of the base, with a datum protrusion (111) formed on each of the side walls. The reinforcing frame includes a plurality of reinforcing pieces (41) located laterally on outer faces of the datum protrusions. The providence of the reinforcing pieces adjacent the datum protrusions can prevent the damage of the datum protrusions or portions of the side walls around the datum protrusions during the not-properly loading or removable process of an IC package onto the insulative housing.

### BACKGROUND OF THE INVENTION

1. Field of the Invention

The present invention relates to the art of electrical connectors, and more particularly to an electrical connector assembly including a reinforcing frame for reinforcing an electrical connector body.

2. Description of the Related Art

One conventional electrical connector assembly is shown in FIGS. 5 and 6 to include an insulative connector body 1″ having peripheral side walls 11″ adapted to receive an electronic component, such as an IC package 3″, and the IC package 3″ accommodated within space defined by the peripheral side walls 11′. Typically, the IC package 3″ is loaded into the connector body 1″ so as to establish electrical continuity between the IC package 3″ and a substrate through the use of the connector body 1″. When loaded into the connector body 1″, the IC package 3″ registers on the interior side walls 11″ of the connector body 1″. If the IC package 3″ is not loaded or handled properly, the side walls 11″ of the connector body 1″ may become cracked or somewhat fragile, thereby causing damage of the connector body 1″, which is undesirable to the user of the connector body 1″. Therefore, there is a need to provide a new electrical connector assembly to resolve the above-mentioned shortcoming.

### SUMMARY OF THE INVENTION

An electrical connector assembly according to one embodiment of the present invention includes an insulative housing adapted to hold a plurality of contacts, and a reinforcing frame removably disposed on the insulative housing. The insulative housing includes a base having a top side, and side walls upwardly extending from the top side of the base, with a datum protrusion formed on each of the side walls. The reinforcing frame includes a plurality of reinforcing pieces located laterally on outer faces of the datum protrusions. The providence of the reinforcing pieces adjacent the datum protrusions can prevent the damage of the datum protrusions or portions of the side walls around the datum protrusions during the not-properly loading or removable process of an IC package onto the insulative housing.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is an exploded, perspective view of an electrical connector assembly according to a first preferred embodiment of the present invention;

FIG. 2 is an assembled, perspective view of the electrical connector assembly of FIG. 1;

FIG. 3 is a cross sectional view of the electrical connector assembly of FIG. 2 taken along line 3-3 thereof;

FIG. 4 is an assembled, perspective view of another electrical connector assembly according to a second preferred embodiment of the present invention;

FIG. 5 is an assembled, perspective view of a conventional electrical connector assembly, with an IC package assembled therein; and

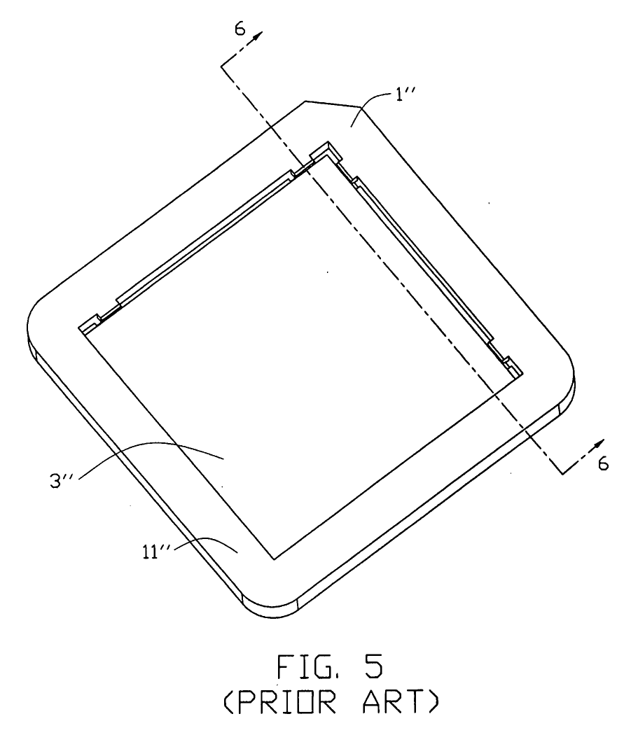

FIG. 6 is a cross sectional view of the electrical connector assembly of FIG. 5 taken along line 6-6 thereof.

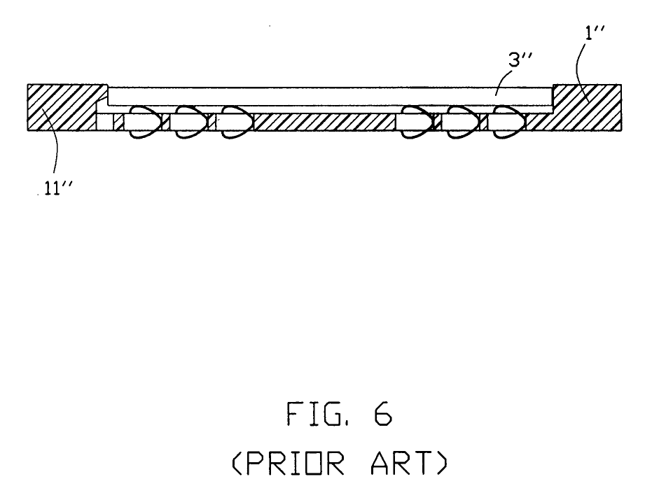

### DETAILED DESCRIPTION OF PREFERRED EMBODIMENT

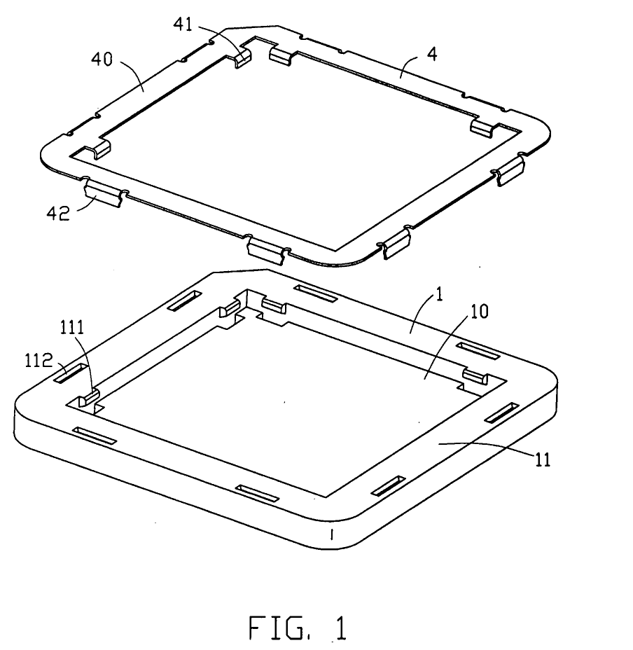

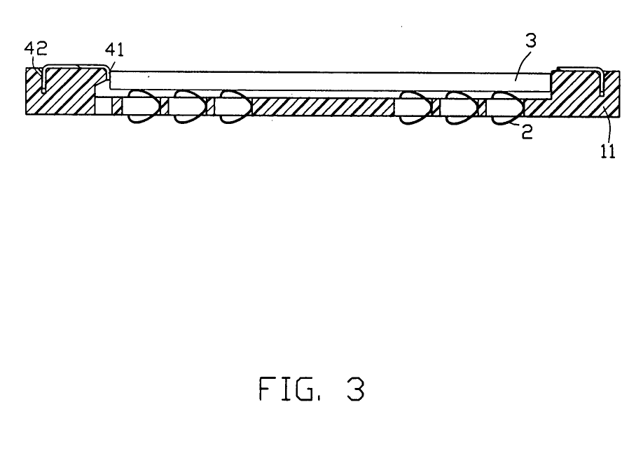

Referring to FIGS. 1 to 3, an electrical connector assembly according to the first preferred embodiment is shown to include an insulative housing or connector body 1, and a reinforcing frame or member 4 assembled onto the connector body 1.

The connector body 1 is adapted to hold a plurality of contacts 2 (as known in the prior art). The connector body 1 includes a base wall 10, and four side walls 11 disposed peripheral to the base wall 10, with each side wall 11 generally transverse to the base wall 10. The side walls 11 are configured to extend from a top side of the base wall 10 upwardly so as to define a substantially rectangular cavity adapted for receiving an electronic component, such as an IC package 3. The side walls 11 of the connector body 1 are formed with a plurality of datum protrusions 111, each datum protrusion 111 defining an outer side face laterally toward the interior cavity above the base wall 10, or located inward of the corresponding side wall 11. In this manner, the IC package 3 is forced to register and align on the datum protrusions 111 in the interior side walls 11 of the connector body 1. Opposite pairs of datum protrusions 111 determine datum dimensions used to precisely locate the contacts 2 and the IC package 3 relative to the side walls 11 of the connector body 1. In this embodiment, the side walls 11 of the connector body 1 defines recesses 112 adapted for receiving retention portions 42 of the reinforcing frame 4 so as to form a mechanical interconnection between the connector body 1 and the reinforcing frame 4 by the combination of the recesses 112 of the connector body 11 and the retention portions 42 of the reinforcing frame 4 (to be later described).

In this embodiment, the reinforcing frame 4 is preferably stamped from a metallic sheet. However, in alternative embodiments, the reinforcing frame 4 may be made of any suitable material that can be used to resist lateral pressure caused by not properly loading of the IC package so as to be not damage to the datum protrusions 111 or the side walls 11 of the connector body 1, the suitable material being such as a sheet plated with a metallic layer.

The reinforcing frame 4 is removably disposed on the connector body 1, and includes four extension pieces 40 in correspondence with four side walls 11 of the connector body 1 to be engageable onto respective top surfaces of the four side walls 11, and a plurality of retention portions 42 located at outer edges of the respective extension pieces 40 for being inserted within the recesses 112 of the connector body 1 so as to hold the reinforcing frame 4 onto the connector body 1. The frame 4 includes a plurality of discrete reinforcing elements 41 extending along inner peripheral edges of the respective extension pieces 40 and substantially perpendicular to the extension pieces 40, with each extending from the top surface of the corresponding side wall 11 to adjacent the outer side face of the corresponding datum protrusion 111. More specifically, each of the reinforcing elements 41 is configured to have at least a portion thereof located laterally on the outer side face of each datum protrusion 111, or flanking and disposed parallel to the outer side face of each datum protrusion 111. As compared with the prior art, the providence of the reinforcing elements 41 adjacent the datum protrusions 111 can prevent the damage of the datum protrusions 111 or portions of the side walls 11 around the datum protrusions 111 during the not-properly loading or removable process of the IC package 3 onto the connector body 1.

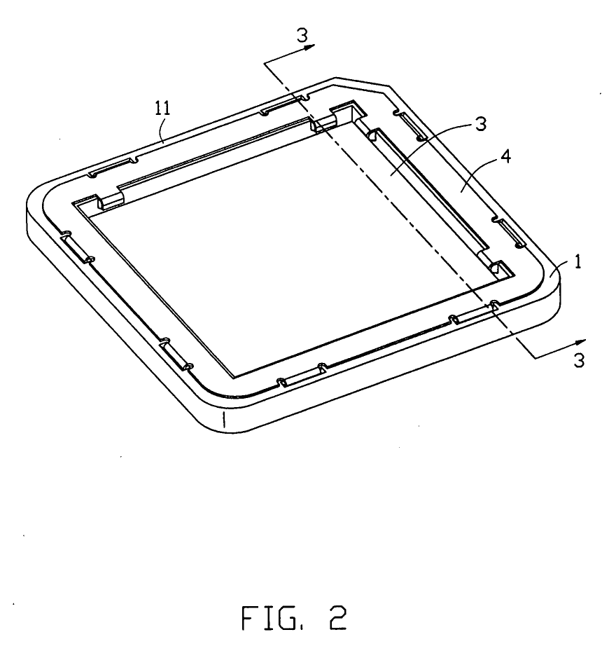

Referring to FIGS. 1 and 2, in assembly, the reinforcing frame 4 is retained onto the connector body 1 by its retention portions 42 interferingly insertable into the recesses 112 of the connector body 1, such that each reinforcing elements 41 is located laterally on the outer side faces of the respective datum protrusions 111 or flanking the side faces of the respective datum protrusions 111.

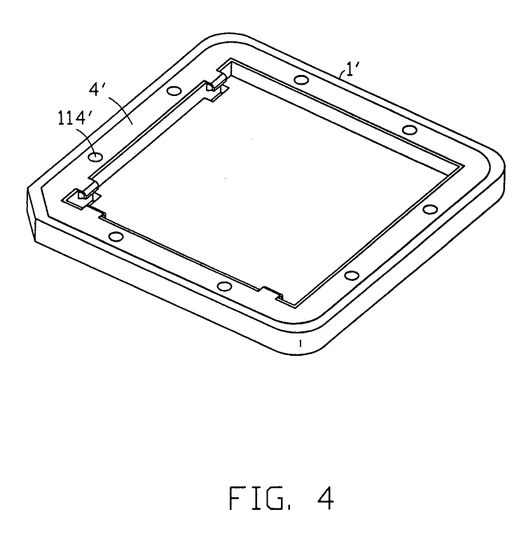

Referring to FIG. 4, an electrical connector assembly according to the second preferred embodiment of the present invention is shown. The electrical connector assembly of this embodiment is similar to that of the first embodiment, except for interconnection between the reinforcing frame and the connector body. More specifically, the connector body 1′ includes retention sections 114′ located adjacent peripheral edges of the reinforcing frame 4′, and the frame 4′ includes recesses (not seen) adapted for receiving the retention sections 114′ of the connector body 1′ so as to form the mechanical interconnection between the frame 4′ and the connector body 1′ by the combination of the recesses of the reinforcing frame 4′ and the retention sections 114′ of the connector body 1′.

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

What is claimed is:

1. An electrical connector assembly comprising:
an electrical connector comprising:
an insulative housing holding a plurality of contacts, the insulative housing including a base having a top side, and side walls upwardly extending from said top side of said base;
a datum protrusion located inward of at least one of said side walls; and
a reinforcing frame disposed on said insulative housing, the frame having at least one datum reinforcing piece located laterally on outer faces of the datum protrusion.

2. The electrical connector assembly of claim 1, wherein the reinforcing frame is made of a metallic material and reinforces said side walls simultaneously.

3. The electrical connector assembly of claim 1, wherein the frame includes an extension piece extending substantially perpendicular to the datum reinforcing piece, the extension piece located on top surfaces of said side walls.

4. The electrical connector assembly of claim 1, wherein the frame includes retention portions for retaining the frame on the insulative housing.

5. The electrical connector assembly of claim 4, wherein the insulative housing includes recesses adapted for receiving the retention portions of the frame.

6. The electrical connector assembly of claim 1, wherein the insulative housing includes retention sections adjacent peripheral edges of the frame for retaining the frame onto the insulative housing.

7. The electrical connector assembly of claim 6, wherein the frame includes recesses adapted for receiving the retention sections of the insulative housing.

8. The electrical connector assembly of claim 1, wherein the frame is removable with regard to the housing.

9. The electrical connector assembly of claim 1, wherein an electronic package is received in a cavity surrounded by the side walls under a condition that said electronic package forcibly abuts against the reinforcing piece.

10. The electrical connector assembly of claim 9, wherein the contacts including deflectable structures induce lateral movement of said electronic package toward said reinforcing piece when said electronic package is urged toward the contacts.

11. An electrical connector assembly comprising:
a connector body holding a plurality of terminals, the connector body having a base wall, and side walls generally transverse to said base wall;
each said side wall defining a top surface, and at least one side face section laterally adjacent said base wall;
a reinforcing device disposed on the connector body, the reinforcing device having at least a portion thereof extending from said top surface to adjacent said at least one side surface section.

12. The electrical connector assembly of claim 11, wherein said side walls are located peripheral to said base wall.

13. The electrical connector assembly of claim 11, wherein the connector body includes four said side walls.

14. The electrical connector assembly of claim 11, wherein at least two said side walls are formed with datum protrusions, each said datum protrusion having said side face section.

15. An electrical connector assembly comprising:
a connector body holding a plurality of terminals, the connector body having a base wall, and side walls generally transverse to the base wall;
each of said side walls having a side face laterally towards the base wall;
a reinforcing member on the connector body, the member including a plurality of reinforcing elements, each having a portion thereof flanking said side face of each side wall.

16. The electrical connector assembly of claim 15, wherein said side walls extend along peripheral edges of said base wall.

17. The electrical connector assembly of claim 15, wherein the member includes extension pieces extending substantially perpendicular to the reinforcing elements, the extension pieces located on top surfaces of said side walls.

18. The electrical connector assembly of claim 15, wherein the frame includes retention portions for retaining the frame on the insulative housing.

19. The electrical connector assembly of claim 18, wherein the insulative housing includes recesses adapted for receiving the retention portions of the frame.

20. The electrical connector assembly of claim 15, wherein the insulative housing includes retention sections adjacent peripheral edges of the frame for retaining the frame onto the insulative housing.
